(19) United States
(12) Patent Application Publication
(10) Pub. No.: US 2018/0052279 A1
(43) Pub. Date: Feb. 22, 2018

(54) Sol-Gel Cladding for Optical Fiber

(71) Applicant: Shasta Crystals, Inc., San Francisco, CA (US)

(72) Inventors: Gisele Maxwell, San Francisco, CA (US); Bennett Ponting, Berkeley, CA (US); Eminet Gebremichael, Emeryville, CA (US); Ruben Magana, Oakland, CA (US)

(21) Appl. No.: 15/556,454

(22) PCT Filed: Mar. 25, 2015
(86) PCT No.: PCT/US2015/022567

§ 371 Date: Sep. 7, 2017

(51) Int. Cl. G02B 6/032; B22F 3/10; F21V 8/00; C03B 37/01; H01S 3/067

(52) U.S. Cl. CPC G02B 6/032; B22F 3/1035; H01S 3/067; C03B 37/011; G02B 6/0065

(57) ABSTRACT

Sol-gel methods, apparatus and compositions for cladding optical fiber cores provide optical fibers, including single crystal optical fiber cores with polycrystalline cladding, having improved performance in a variety of applications, such as fiber lasers.

### BACKGROUND

An optical fiber is typically a circular cross-section dielectric waveguide composed of a dielectric “core” material surrounded by another dielectric “cladding” material with a lower refractive index than the core. The optical fiber transmits light, radiation in the ultraviolet (UV), visible and/or infrared (IR) range of the electromagnetic spectrum, along its axis, by the process of total internal reflection. Total internal reflection occurs when light traveling in an optically dense medium hits a boundary with a medium having a lower refractive index at an angle higher than the critical angle for the boundary, resulting in the light being completely reflected. In this way, light travelling in optical fibers is confined to the core. Light travels through the fiber core, reflecting back and forth off the boundary between the core and cladding.

Optical fibers having various compositions and scales have an array of applications including data transmission (e.g., for telecommunications and computer networking), sensors, illumination and as fiber lasers.

There have been several approaches to the development of high-power (multi-kilowatt) lasers. Bulk single crystals are used extensively for their excellent thermal conductivity, efficiency, and mechanical resistance. However, heat dissipation becomes a problem in these systems at very high powers. A good remedy is to use fibers instead of bulk crystals. Fiber lasers find many applications in materials processing, including cutting, welding, drilling, and marking metal. Their performance is commensurate with their output power. Conventional fiber lasers, in which the core gain medium is composed of a single fused silica strand, can emit only about 1.2 kW of power. They are limited by the physical properties of rare earth-doped silica materials.

### SUMMARY

Single crystal optical fibers combine features of laser crystals and doped glass fibers. They have the advantages of both guiding laser light and matching the efficiencies found in bulk crystals, making them ideal candidates for high-power laser and fiber laser application. This disclosure provides sol-gel methods, apparatus and compositions for cladding optical fiber cores. Resulting optical fibers, including single crystal optical fiber cores with polycrystalline cladding (i.e., all-crystalline optical fibers), have improved performance in a variety of applications, such as fiber lasers.

Among various embodiments disclosed herein is a method of making an optical fiber via a sol-gel process. The method involves applying to an optical fiber core a coating of a sol-gel of material having a refractive index lower than that of the optical fiber core, to form a cladding precursor. Solvent from the cladding precursor applied to the fiber core, and the cladding precursor is sintered to form an optical fiber having a cladding comprising a concentric layer of the material on the optical fiber core.

Also described is a sol-gel coating apparatus. The apparatus includes a sol-gel reservoir having a bottom and sidewalls. A fiber feed guide is mounted in the bottom of the reservoir, the fiber feed guide for feeding a fiber entering the fiber feed guide from below into a sol-gel contained in the reservoir. A tether is mounted above the fiber feed guide and the reservoir, the tether for attachment to a fiber fed through the fiber feed guide, to draw the fiber through a sol-gel in the reservoir.

Further disclosure is provided for sol-gel-formulated cladding compositions, including a sol-gel composition consisting essentially of CaGdAlO₄, and optical fibers of various composition, including all-crystalline optical fibers having a single crystal core and a polycrystalline cladding comprising or consisting essentially of YAG, Al₂O₃ or CaGdAlO₄.

These and other features will be described in more detail below with reference to the drawings.

### BRIEF DESCRIPTION OF THE DRAWINGS

FIG. 1A is an overall schematic of a LHPG fiber crystal production apparatus consistent with various embodiments disclosed herein.

FIG. 1B is a schematic of the initiation phase of an LHPG process.

FIG. 1C is a schematic of the continuous fiber growth phase of an LHPG process.

FIG. 2 is a schematic of an apparatus for conducting sol-gel cladding of an optical fiber core consistent with various embodiments disclosed herein.

FIG. 3 is a process flow depicting operations in a fiber core cladding method consistent with various embodiments disclosed herein.

FIGS. 4A-B depicts an optical fiber consistent with various embodiments disclosed herein.

FIGS. 5-7, depict X-ray diffraction (XRD) plots illustrating the purity of sol-gel cladding materials in accordance with various embodiments disclosed herein.

### DETAILED DESCRIPTION

### Introduction

As described herein, an optical fiber is substantially circular cross-section dielectric waveguide composed of a dielectric core surrounded by dielectric cladding, the cladding having a lower refractive index than the core such that the optical fiber transmits light in the ultraviolet (UV), visible and/or infrared (IR) range of the electromagnetic spectrum along its axis by the process of total internal reflection. Sol-gel methods, apparatus and compositions are described for cladding optical fiber cores. Resulting optical fibers, including single crystal optical fiber cores with polycrystalline cladding (i.e., all-crystalline optical fibers), have improved performance in a variety of applications, such as fiber lasers. The sol-gel cladding methods, apparatus and compositions are primarily described with respect to optical fibers composed of single crystal optical fiber cores with polycrystalline cladding in the context of fiber lasers. However, the disclosure is not so limited. The sol-gel cladding technology described may also be used to coat polycrystalline or amorphous (e.g., glass) fiber cores, the cladding may or may not be polycrystalline, and the resulting optical fibers may be useful in a variety of applications.

### Single Crystal Fiber Core Fabrication

Disclosed herein are various embodiment fiber crystal production apparatuses and associated methodologies which employs the laser heating pedestal growth (LHPG) technique to produce thin crystal fibers of various materials. Traditionally, crystal fibers produced by such methods have been limited to having diameters of on the order of about 100 μm or greater. Disclosed herein are improved LHPG apparatuses and associated methodologies capable of producing thin crystal optical fibers with diameters on the order of 150 μm or less, and in particular on the order of 100 μm or less. These thin fibers may be used for various applications such as, for instance, serving as the wave guide (optical fiber) core in a fiber laser.

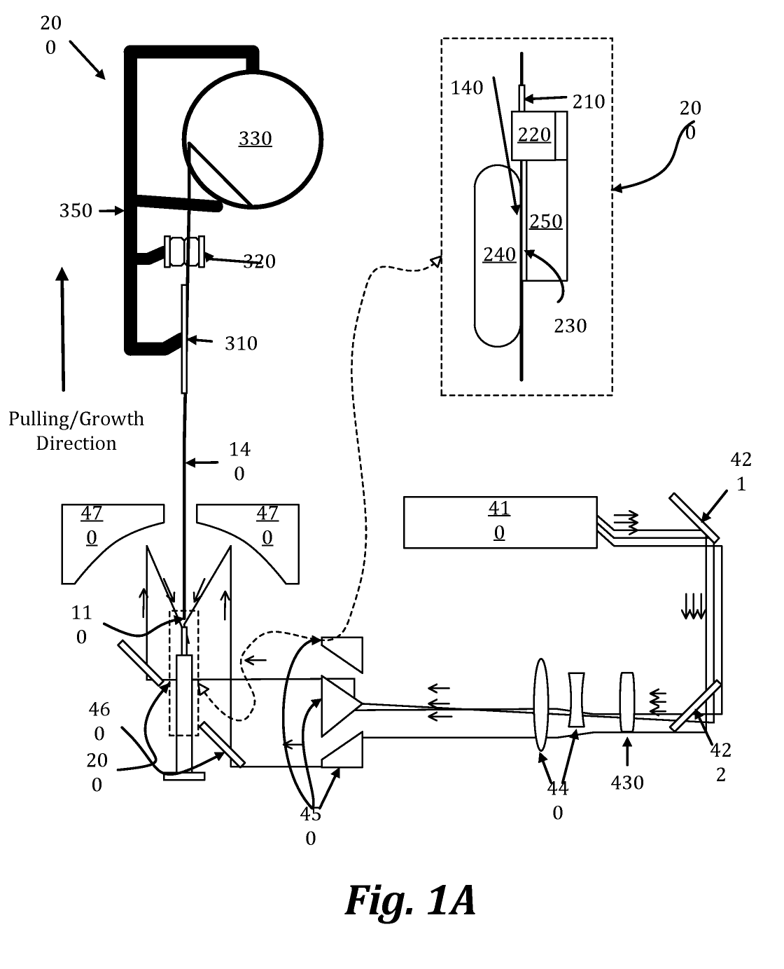

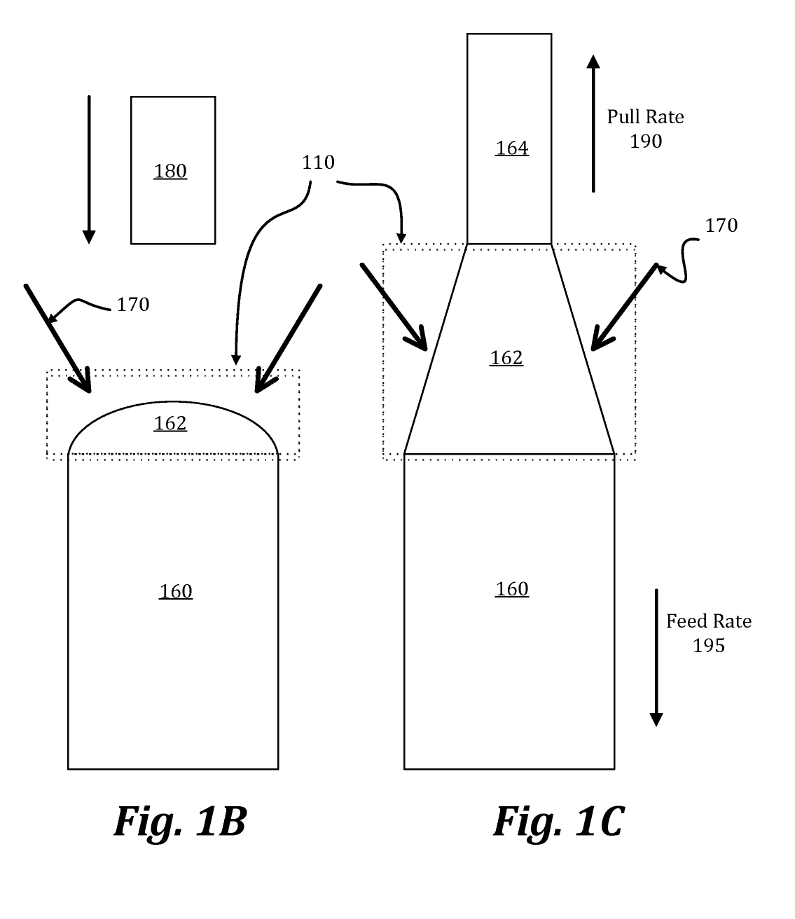

FIG. 1A displays an overall schematic of such an LHPG fiber crystal production apparatus consistent with various embodiments described herein. As shown in the figure, the apparatus 100 comprises lower feed guide 200, and upper fiber guide 300, and a source of optical energy 400 including laser source 410 and various optical components 420 et seq. for guiding the laser emission from its source 410 to the region where the crystal fiber is formed through optical heating. As also shown in the figure, this region of optical heating and crystal formation is referred to as molten zone 110 and it is located between the lower feed guide 200 and the upper fiber guide 300—in this embodiment, just slightly vertically above the lower feed guide.

While lower feed guide 200 and upper fiber guide 300 precisely locate the growing crystalline fiber within the LHPG apparatus, another key component is a stable and uniform source of optical energy for heating and melting the fiber material within the molten zone. As detailed in FIG. 1A, in some embodiments, an LHPG apparatus may employ an optical energy source 400 including a laser source 410, various flat turning mirrors 421 and 422, an attenuator 430, a beam expander 440, a reflaxicon 450, an elliptical turning mirror 460, and a parabolic focusing mirror 470. The optical path from laser source 410, through these various optical components, and ultimately to the molten zone is schematically indicated in FIG. 1A. As shown in the figure, a coherent light beam leaves laser source 410 (e.g. a CO₂ laser of 10.6 μm wavelength, typically having a power range between about 1 W and 100 W), is directed by the turning mirrors 421 and 422 through attenuator 430 to reduce the beam's intensity to a suitable level, and then into beam expander 440. Having been thus initially radially expanded, the increased diameter beam then impinges upon reflaxicon 450 which radially expands the beam further but leaves a gap in the center—i.e., it forms a ring-shaped beam still axially symmetric along its axis of propagation. Note that a cross-sectional view of reflaxicon 450 is depicted in FIG. 1A, and so it appears schematically as three disjoint pieces, though it should be understood, of course, that reflaxicon 450 is an optical device with two annular and concentric reflective surfaces which work to produce the expanded ring-shaped beam just described. At his point, the ring-shaped beam is still propagating horizontally, but the next element along the optical path is elliptical turning mirror 460 (again shown in cross-section, but it should be understood that it represents one reflective surface) which redirects the horizontal ring-shaped beam to propagate vertically with the center axis of the now vertical ring-shaped beam roughly aligning with the axes of the upper and lower guides and growing crystalline fiber. Thus, at this point, the beam is propagating parallel to the fiber in a ring around it, but not yet contacting it. A parabolic focusing mirror 470, focuses the beam symmetrically down upon the molten zone to create a spatial region of roughly uniform radiation intensity, and of sufficient optical radiation intensity to cause the heating and melting of a fiber crystal source material. In an operation of forming a thin fiber crystal, the apparatus 100 operates by feeding a fiber or rod of source material 140 (hereinafter referred to as just source material) from below into the region of space referred to as molten zone 110 in FIG. 1A. The source material, may be a pressed and/or sintered and/or cut pellet or rod of raw polycrystalline stock material, or it may be a crystal fiber formed from a previous LHPG operation—here being processed again to make the crystalline fiber thinner still or to improve its crystal structure through another round of melting and crystallization, or typically to achieve both goals. In the former case, for example, the source material may be a raw polycrystalline YAG stock of about 1 inch long and 1 mm square.

Once within the molten zone, the raw source material is heated with optical energy from source 400 to the extent that it is melted into a molten state. The molten material is then pulled upwards and out of the molten zone whereby it cools into a thin single crystal fiber 150. Generally, this process takes place continuously—i.e., the raw source material is moved in continuous fashion into the molten zone by being pushed from below with lower feed guide 200, while simultaneously a thin crystalline fiber is pulled out of the molten zone from above by upper fiber guide 300.

However, before the crystalline fiber may be drawn continuously from the melt, the LHPG process must be initiated. As illustrated in FIG. 1B, this is done by positioning rod 160 (or pellet, fiber, etc.) of the raw source material in the path of one or more laser beams 170 which are focused down upon a tip of such material to melt it forming melt 162 and, accordingly, the aforementioned molten zone 110. As further shown in FIG. 1B, a seed crystal 180 is then lowered into the melt 162—e.g., by attaching said seed crystal to a string and mechanically lowering it—and when it is subsequently withdrawn from the melt, as shown in FIG. 1C, the melted source material adhered to it is removed from the vicinity of the focused laser whereby it may begin to cool and crystallize forming the crystal fiber 164—which then may be continuously pulled from the melt 162 (so long as the molten zone is sufficiently fed from below with sufficient source material as just described). Note that by choosing the orientation of the seed crystal 180 as it is lowered into and pulled from the melt 162, a fiber 164 having substantially the same crystal orientation may be produced. Also note that laser 170 is FIG. 1B is depicted in schematic cross-section, so although two arrows appear in the figure to indicate the direction of laser propagation into the melt, it should be understood that the two arrows could represent two laser beams, or they could more preferably represent a cross-section of a single conical beam such as that which would be produced by the optical elements shown in FIG. 1A—specifically, reflaxicon 450, elliptical turning mirror 460, and parabolic focusing mirror 470.

While the foregoing LHPG-based technique results in the conversion of polycrystalline source material into a single-crystal fiber, the process may also work to achieve a reduction in diameter of the fiber relative to the diameter of the raw source material (or a further diameter reduction if a previously formed fiber is used as the source material as indicated below). As illustrated in FIG. 1C, this may be done by making the translational rate 195 at which the fiber is pulled out of the molten zone from above (by upper fiber guide 300) greater than the translational rate 190 at which the raw source material is pushed into the molten zone from below (by lower feed guide 200). Conceptually, this is akin to the molten material being stretched as it is formed into a crystal. Accordingly, the diameter of the crystal material exiting the molten zone is generally less than the diameter of the polycrystalline material entering the molten zone by some diameter reduction factor. In practice, it has been found that diameters may be effectively reduced by factors of between about 1.5 and 10, or more particularly between about 2 and 5, or yet more particularly between about 2.5 and 4, e.g., about 3. Note that in practice a fiber of “constant” thickness will still exhibit some variation in its diameter along its length. Accordingly, for purposes of this disclosure, a fiber's diameter or thickness is hereby defined as its radially averaged thickness (e.g., the fiber may be slightly ellipsoidal) averaged over a portion of the fiber's length. This is referred to herein as the fiber's “average thickness” or “average diameter.” Generally, and unless indicated otherwise, said portion of the fiber's length being averaged over is a region of the fiber produced via the LHPG process once having stabilized. Furthermore, unless indicated otherwise, this length is assumed to be about 1-10 cm, in particular 2 cm. Using these definitions, a constant diameter fiber is one whose average thickness deviates by about 5% or less, and more preferably by about 2% or less over the portion of the fiber's length said to have a constant diameter.

Moreover, the foregoing process may be repeated serially on the same physical material and apparatus to form fibers of progressively narrower diameter and, in some embodiments, progressively higher quality (more uniform) crystal structure. Thus, for instance, if the diameter reduction factor is about 3, to get to a sub-100 μm fiber starting from a 1 mm YAG source feed rod, a 3 stage diameter reduction process may be performed, e.g.: a first stage going from 1000 μm down to 350 μm; a second stage going from 350 μm to 120 μm; and finally a third stage effecting a diameter reduction from 120 μm to 40 μm. It is noted that these stages may be conducted sequentially using a single LHPG apparatus by re-feeding a formed crystal fiber from a prior stage back into the apparatus to serve as the raw stock for the next stage, or successive diameter reductions may be performed via an apparatus having multiple LHPG stations each individually dedicated to a particular stage of the complete diameter reduction process. Thus, the foregoing LHPG-based technique may be used to grow long, flexible, single-crystal fibers. It is to be noted furthermore that the foregoing technique may be performed at ambient temperate and pressure conditions to produce such fibers.

In addition to setting the relative translational rates at which the fiber is pulled from above versus pushed from below to effect a diameter reduction, in certain embodiments, it is feasible to adjust the relative translational rates of push and pull during the crystal fiber formation process. This might be done as part of a closed-loop diameter-control feedback circuit designed to ensure that the fiber being produced has a consistently uniform diameter over substantially its entire length (or over a particular portion of its length). Such a closed-loop feedback circuit may operate by continuously monitoring the diameter of the fiber as it is produced and automatically making process adjustments accordingly. Appropriate techniques and apparatuses for monitoring the fiber diameter as it is produced are described in detail in: L. S. Watkins, “Scattering from side-illuminated clad glass fibers for determination of fiber parameters,” Journal of the Optical Society of America 64, 767 (1974); and M. M. Fejer, G. A. Magel, and R. L. Byer, “High-speed high-resolution fiber diameter variation measurement system,” Applied Optics 24, 2362 (1985); each of which is hereby incorporated by reference in its entirety for all purposes.

In other embodiments, varying relative pull/push translational rates might be done in order to intentionally vary the diameter of the crystal fiber being produced to achieve some predetermined radial profile appropriate for the crystal fiber's use in particular applications. For example, in some applications, it may be advantageous to produce a fiber having a radially flared end, or a fiber having a constantly tapering diameter along some portion of its length. In principle, controlling the relative pull and push rates may be done by varying the push rate, varying the pull rate, or varying both. In practice, it has been found effective to vary just the push rate while keeping the pull rate constant (both in order to produce a constant diameter crystal fiber via a closed-loop, locked-in feedback mechanism, and also in scenarios where it is desirable to generate a variable diameter crystal fiber of some predetermined profile).

Referring to the expanded view of one embodiment of a lower feed in FIG. 1A, lower feed guide 200 may include a lower guide tube 210 and a belt 240 which, when it advances, pushes the raw source fiber or rod upwards through the lower guide tube 210. In this particular embodiment, the lower guide tube 210 is supported by guide tube mount 220 which is itself attached to mount structure 250. As shown in the figure, mount structure 250 also has the function of supporting a guide block 230 having a low-friction surface, such as such a surface composed of polytetrafluoroethylene (PTFE) or polyoxymethylene, e.g., DuPont products, Teflon™ and Delrin™, respectively (although it should be understood that other appropriate low-friction materials may be substituted), which provides additional support for the raw source material as it is pushed upward.

Depending on the embodiment, the guide block 230 may have a groove formed in it (not visible in perspective shown) within which the raw source resides as it is pushed against by belt 240. Thus, the raw source material is sandwiched between belt 240 and a groove in guide block 230 (e.g., a PTFE groove) such that when the belt advances the raw source material is pushed against and upward through the groove and into and through lower guide tube 210. This sort of design provides for the smooth movement of the raw source material into the molten zone as shown in FIG. 1A. Moreover, lower guide tube 210 orients the raw source as it exits the fiber feed guide 200 and enters the molten zone. Lower guide tube 210 may have an interior diameter just slightly larger than the diameter of the raw source material, such that lower guide tube is able to precisely locate the raw source material horizontally within the molten zone. Thus, in some embodiments, the interior diameter of the lower guide tube 210 may be selected to be about 10% larger than the diameter of the raw source material being processed or less, or more particularly about 5% larger or less. Similarly, the depth of the groove in guide block 230 may be selected to be between about 10 and 50% of the diameter of the source material, or more particularly between about 20 and 40% of the diameter of the source material.

As stated above, to cause a reduction in the diameter of the crystal fiber, the fiber is generally pulled from above with upper fiber guide 300 at a translation rate greater than the rate at which it is pushed from below with lower feed guide 200. As shown in the figure, upper fiber guide 300 includes a frame 350 which supports an upper guide tube 310, a pair of guide pads 320, and a spooling drum 330.

Upper guide tube 310 serves the counter-role of lower guide tube 210 in the sense that it locates and stabilizes the fiber in the horizontal dimensions while it is pulled upward, however, since the single-crystal fiber exiting the molten zone is generally thinner than crystal fiber or raw polycrystalline source material entering the molten zone, the upper guide tube 310 generally has a proportionally smaller interior diameter relative to that of the lower guide tube 210. Thus, depending on the embodiment, the interior diameter of the upper guide tube 310 may be selected to be about 10% larger than the diameter of the crystal fiber exiting the molten zone or less, or more particularly about 5% larger or less.

Additional horizontal stabilization as the crystal fiber is pulled upward by upper fiber guide 300 may be provided by guide pads 320 of the fiber guide 300. The guide pads 320 may be compressible and/or elastic so as to provide a slight horizontal force to locate the fiber in the horizontal dimensions. Thus, the guide pads 320 may apply slight pressure to the fiber to precisely locate it, but not so much pressure as to create substantial frictional force which would hinder the fiber's vertical motion as it is pulled upwards. To achieve the right balance between these considerations, the guide pads may be made from a foam or other suitable compressible material and coated with a smooth, low-friction material, such as a thin polymeric material (e.g., polytetrafluoroethylene (PTFE) or polyoxymethylene), and one which also does not adhere substantially to the fiber as it is pulled. In some embodiments, the pressure applied to the fiber by the guide pads may be adjustable by a guide pad orienting device that may translates one pad toward the other, or both pads towards each other. The orienting device may employ a screw, spring-loading, clamp or some other suitable pressure producing mechanism to achieve the foregoing.

The actual pulling force is generated by the rotation of spooling drum 330, and as shown in the figure, the spooling drum is located such that a vertical vector tangent to its surface—i.e., tangent at the point on the drum which first contacts the fiber as it is spooled—is vertically aligned with the upper fiber guide 310 (again, as shown in the figure). As stated, the spooling drum provides the vertical pulling force, and it also, for sufficiently thin and flexible fibers, may wrap the fiber around itself for compact fiber storage during processing. In other cases—where the fiber is not sufficiently thin and flexible—the end of the fiber may be attached (by some mechanism, e.g., glued) to another thin flexible material (e.g., a string) which is then directly pulled by the spooling drum—in order to provide vertical pulling force on the fiber as it is formed but without damaging the fiber (by forcing it to bend to the diameter of the spooling drum).

### Sol-Gel Cladding

In order to complete an optical fiber, a fiber core (or core fiber), the portion of the optical fiber through which the light will travel, must be clad with a material having a refractive index lower than that of the optical fiber core to provide the needed total internal reflection. Sol-gel-based cladding methods, apparatus and compositions have been found to be advantageous for this purpose.

Sol-gel process is a wet-chemical technique for producing solid materials from small molecules. The process involves conversion of monomers into a colloidal solution (sol) that acts as the precursor for an integrated network (gel) of either discrete particles or network polymers. Sol-gel process has been used for the fabrication of both glassy and ceramic materials, but is not known to have been previously used in the context of single crystal optical fiber cladding.

This disclosure describes a method of making an optical fiber via a sol-gel process. The method involves applying to an optical fiber core a coating of a sol-gel of material having a refractive index lower than that of the optical fiber core, to form a cladding precursor. Solvent from the cladding precursor applied to the fiber core, and the cladding precursor is sintered to form an optical fiber having a cladding comprising a concentric layer of the material on the optical fiber core.

Substrate Preparation

To prepare for cladding, the fiber core may first be cut to the desired length. Any suitable method may be used. For example, a low speed saw equipped with a diameter of 0.2 mm and a 10μ grit size diamond blade, such as an IsoMet® Low Speed Cutter available from Buhler, Lake Bluff, Ill., may be used to cut single crystal fibers. A block with grooves may be used to secure a single fiber in place. For example a 2 by 1.5 inch graphite block with precut grooves of 0.2-1.2 mm width and lengths of 3-5 cm can be used, and the fiber can be placed inside a groove that is no more than 0.1 mm greater than its diameter. Once in place, the fiber can be secured to the block for cutting. For example, pieces of a low melting adhesive, such as Crystal Bond™ 509, can placed on the block and the block can be placed on top of a hot plate. Once the adhesive has melted into the groove with the fiber, the block can be cooled before mounting onto the saw.

An alternative cutting method, useful especially for smaller fibers with diameters of 30-100 μm, is scoring the fiber barrel with a diamond scribe. While holding the fiber at two points on either side of the score, a small scratch is made with the scribe. Then a small amount of pressure is applied on one side while holding the other side in place or by pulling one side while still holding the second side in place and breaking it into two pieces.

After cutting, the ends of the fiber may be polished to reduce back reflection. A variety of methods are known for fiber polishing. For crystals and crystal fibers with diameters of about 30 μm-400 μm, a capillary glass tube can be used for support. Variation in size to up to about 300% of the diameter of the fiber can be used, but a close fitting capillary tube (e. g, about 10% in size variation) has been found to provide good results. One or more fibers can be inserted inside a capillary tube with the closest inner diameter to the fiber(s). The length of the tube can be at least about 1 cm, and can be as long as 100 cm or more. To secure the fiber(s) in place, an adhesive, such as Crystal Bond™ 509, is melted and applied around the fiber(s) and the fiber(s) is pulled through the capillary tube in such a way that it is flush and has no air pockets at the tube/fiber(s) interface. The tube with the fiber(s) is then mounted onto sample holder, for example one composed of a metal or alloy such as aluminum, with a “V groove.” The depth of the V groove may be, for example 0.8 cm, and have a fastener, such as a clamp or screw top latch that presses down gently on the capillary tube, to hold it in place. Within the groove of the sample holder, the tube is fastened in place and adjusted so that no more than about 1 mm of fiber face protrudes beyond the edge of the holder. For crystals with diameters of 400 μm or more, a single bare fiber is secured inside an aluminum sample holder in the same manner as the capillary glass tube.

Next, a lapping and polishing tool, such as an Ultrapol™ End and Edge Polisher, available from Ultra Tec, California, can be used to polish the face of the fiber(s). According to this process, the sample holder is mounted and fastened onto the arm of the polisher and the lapping process begins with the polisher arm resting parallel to the surface of the lapping plate. Alumina lapping and polishing films are sufficient to produce a fine surface finish in many cases, although diamond films can provide better results for some materials. During polishing, distilled water can be used to both wash away debris and function as a coolant. In order to remove excess adhesive from the face of the fiber, a 30 μm grit aluminum oxide lapping film can be used at speeds of 80 to up to 400 RPM. Next, a sequence of aluminum oxide lapping films with decreasing grit sizes of 15 μm, 9 μm, 5 μm and 1 μm can be used. At each stage, the sample face is processed for several seconds to several minutes based on inspection under a high magnification fiber microscope (e.g., 5×-40× magnification). To increase the processing speed and produce a higher quality polish, a lateral oscillation of the arm can be added. The length of the sweep can be kept small (0.5-1 cm) in order to allow particles to be washed away but still be less susceptible to variation in height due to minor wobbling movement of the polishing plate.

Depending on the size of the fiber and the appearance of any unidirectional scratches made during the process, the amount of weight or counterweight can be adjusted (range of 0-51 g available). Care should be taken that the lapping/polishing pad is held in place during the polishing and air bubbles are eliminated. Once a scratch free polished surface is achieved, the fiber is cleaned. The fiber faces can be cleaned by using water, force gas and finally wiping with lint free lens wipes (e.g., such as are available from Altos Photonics) until all debris is removed. The most efficient use of the lens paper is to hold the fiber and drag it gently in one direction. Finally, the barrel of the fiber is inspected under a microscope to check for any cracks, scratches, or other deformities.

To minimize defects, just prior to application of the sol, the substrates can be cleaned thoroughly by soaking in acetone or high purity alcohol and then in water in an ultrasonic bath for several minutes.

Sol-Gel Synthesis

A sol is initially formed by combining solid precursor monomers with a liquid solvent. Typical precursors are metal alkoxides and/or metal chlorides. Typical solvents are water and/or ethanol. Dopants, such as rare earth elements, can be introduced in the sol and end up uniformly dispersed in the final product. As liquid is removed, the sol gradually evolves towards the formation of a gel-like diphasic system containing both a liquid phase and solid phase. Metal alkoxides and metal chlorides undergo hydrolysis and polycondensation reactions in water to form a colloid. The basic structure or morphology of the resulting solid phase can range anywhere from discrete colloidal particles to continuous chain-like polymer networks. See, e.g., Hench, L. L. and West, J. K., “The Sol-Gel Process”. Chemical Reviews 90: 33 (1990); Klein, L. C. and Garvey, G. J., “Kinetics of the Sol-Gel Transition” Journal of Non-Crystalline Solids 38: 45 (1980).

Additional liquid (solvent) phase is generally removed in a drying operation. This drying is typically accompanied by a significant amount of shrinkage and densification. The rate at which the solvent can be removed is ultimately determined by the distribution of porosity in the gel. The microstructure of the final component will be strongly influenced by changes imposed upon the structural template during this phase of processing.

After drying, a thermal treatment, or firing process, is generally used to enhance mechanical properties and structural stability via sintering.

This disclosure provides sol-gel based methods, apparatus and compositions suitable for cladding fiber cores to form optical fibers. The methods, apparatus and compositions may be particularly useful form forming polycrystalline cladding on single crystal fibers, in particular very thin single crystal fibers, for example less than 150 μm in diameter, less than 100 μm in diameter or less than 50 μm in diameter. As discussed further below, such fibers can be difficult to handle using conventional sol-gel processing techniques. While this disclosure primarily references such thin single crystal fibers with polycrystalline cladding, the methods, apparatus and compositions are not so limited and may also find practice with larger fiber cores, amorphous or polycrystalline cores, or amorphous claddings.

A sol for cladding optical fiber cores can be prepared using sol-gel mechanisms that require very low reacting temperatures (under 100° C.). As one example, yttrium aluminum garnet (YAG) can be made via the hydrolysis and condensation reaction of yttrium oxide (Y₂O₃) and aluminum nitrate Al(NO₃)₃. The reaction can be carried out in acidic media to prevent flocculation and with the use of citric acid as a pacifier. Suitable reagents aluminum nitrate monohydrate (>98%), yttrium oxide (99.99%), 1.0 M acetic acid and citric acid monohydrate, (98%) are all available from Aldrich Chemical Company. Yttria can be firstly dissolved in about 0.2M acetic acid by stirring at about 60° C. for about 2-3 hours while covered. The aluminum precursor can then be added along with citric acid and the mixture stirred at about 80° C.

After approximately 2 hours of stirring at 80° C., an increase in viscosity is evident. Sol-gel viscosity is determined by the amount of time the gel is allowed to condense at this stage. If the gel is too thick it will either crack when coated or the adhesion will be poor and droplets will form. In order to produce thin coatings that are crack free, the solution is not allowed to reach gelation. A suitable viscosity for coating fiber cores with cladding to form optical fibers is generally about 3-10 cSt, depending on the diameter of the fiber to be coated and processing considerations, such as the coating application arte and the desired coating thickness.

Cladding

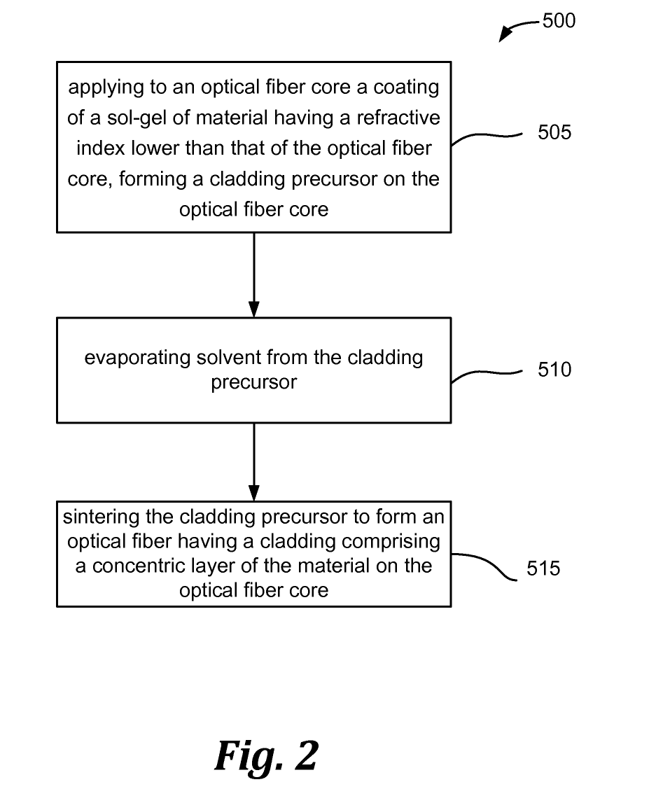

Once the cladding sol-gel is synthesized, a coating method is used to clad a fiber core substrate in a method of making an optical fiber via a sol-gel process. Referring to FIG. 2, the method 500 involves applying to an optical fiber core a coating of a sol-gel of material having a refractive index lower than that of the optical fiber core, to form a cladding precursor (505). Solvent is evaporated from the cladding precursor applied to the fiber core (510), and the cladding precursor is sintered to form an optical fiber having a cladding comprising a concentric layer of the material on the optical fiber core (515). Optical fibers of various compositions, including fibers having a single crystal core and a polycrystalline cladding (i.e., all-crystalline optical fibers), may be made in this way.

Thicker substrates may dip-coated in the sol, for example at 1-10 cm/min at room temperature and ambient pressure and allowed to dry very slowly in air at room temperature for about 24 hrs. However, for thinner fiber substrates, particularly those thinner than about 150 μm (i.e., having an average diameter of about 150 μm), difficulties are encountered with the dip coating as the fibers tend to stick to the sides of the sol gel vessel, or are kept out of the sol by surface tension. For such thin fibers, a draw coating method and apparatus has been developed. While developed for thin fibers, this draw coating apparatus can be used for fibers of any thickness and composition.

The cladding may be applied to the optical core fiber using a sol-gel draw coating apparatus. The apparatus includes a sol-gel reservoir having a bottom and sidewalls. A fiber feed guide is mounted in the bottom of the reservoir, the fiber feed guide for feeding a fiber entering the fiber feed guide from below into a sol-gel contained in the reservoir. A tether is mounted above the fiber feed guide and the reservoir, the tether for attachment to a fiber fed through the fiber feed guide, to draw the fiber through a sol-gel in the reservoir.

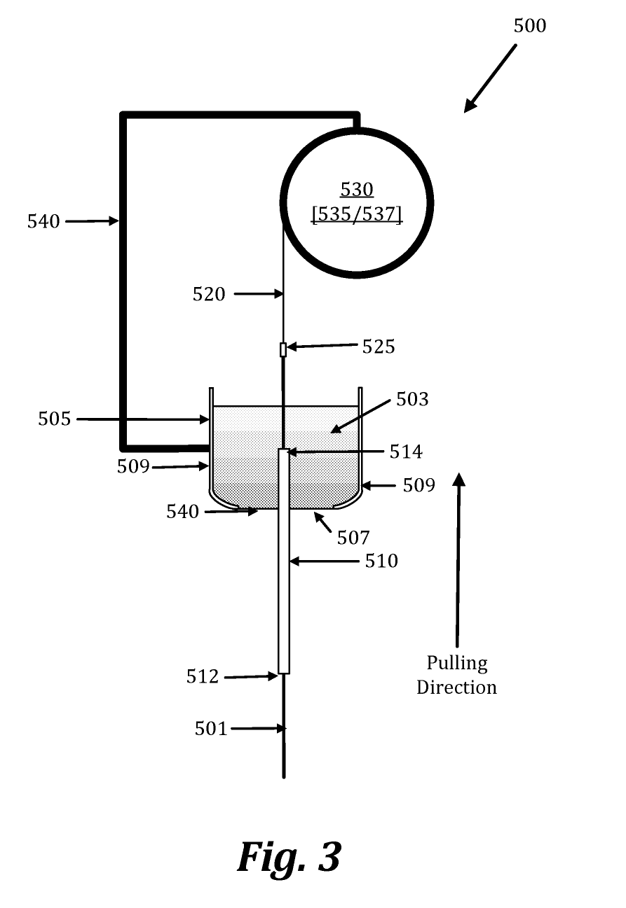

Such a sol-gel coating apparatus is depicted in FIG. 3. The sol-gel coating apparatus 600 is composed of a sol-gel reservoir 605 having a bottom 607 (directional terms are used herein relative to gravity) and sidewalls 609. In some embodiments, the reservoir 605 has a substantially circular axial cross-section. The reservoir 605 can be made of any suitable material, compatible with the sol-gels to be contained. For example, the reservoir may be mainly composed of a glass, for example borosilicate glass, or quartz. The volume of the reservoir 605 can be selected based on factors such as the length and diameter of the fiber core substrate to be coated, the thickness of the coating to be applied, and other factors. In various embodiments, the reservoir 605 has a depth of about 0.5-1 cm, for example about 0.8 cm, and a width/diameter of 0.5 to 1.5 cm, for example a diameter of about 0.7 cm, for a volume of about 0.2-1.5 ml, for example, about 0.25 ml.

A fiber feed guide 610 is mounted in the bottom 607 of the reservoir 605. The fiber feed guide 605 is for feeding a fiber 601 entering the fiber feed guide 605 from below into a sol-gel 603 contained in the reservoir 605. It should be noted that the fiber 601 and the sol-gel 603 do not form part of the apparatus 600, but are shown in the figure in order to provide context for the apparatus 600 in operation.

The fiber feed guide 610 may be a capillary tube having a suitable length, interior diameter and material composition. For example, the fiber feed guide 610 may be a glass, for example borosilicate glass, or quartz capillary tube having an inside diameter just slightly larger than the diameter of the fiber to be coated and an outside diameter of about 0.5 to 1 mm. In some embodiments, the inside diameter of the fiber feed guide 610 may be selected to be about 10% larger than the diameter of the fiber to be coated, or less. The fiber feed guide 610 is disposed in the bottom 607 of the sol-gel reservoir 605 to provide a reliable path for a fiber to enter the reservoir, and in such a manner that a sol-gel in the reservoir is reliably contained. In various embodiments, the fiber feed guide 610 is mounted in the bottom 607 of the sol-gel reservoir 605 in a membrane seal 608, such as a latex membrane. In one embodiment, a latex membrane is stretched over the lower end of the reservoir 605 and attached to provide a seal, for example by a band clamp. A capillary tube fiber feed guide 610 is inserted in the center of the slightly stretched latex membrane, and glued in place.

The fiber feed guide 610 is generally of sufficient length and is positioned in the reservoir bottom so as to facilitate the steady, even pulling of a fiber through a sol-gel in the reservoir 605. For example, the fiber feed guide 610 may be about 1 cm to 3 cm, for example about 1.5 cm, in total length. The fiber feed guide 610 is disposed in the reservoir 605 such that a fiber 601 drawn through the feed guide exits an upper end 614 of the feed guide below an upper rim of the reservoir sidewalls 609. The fiber feed guide 610 may extend about 1 cm to 2.5 cm, for example about 1 cm below the bottom 607 of the reservoir 605, and extend about 0.5 to 1 cm, for example about 0.5 cm into the reservoir.

The reservoir can be attached to a mount 640 at an appropriate height and position to facilitate use, and in particular to allow for unhindered access from below of a fiber to be coated 601 to the bottom end 612 of the fiber feed guide 610.

A tether 620 is mounted above the fiber feed guide 610 and the reservoir 605. The tether 620 is for attachment to a fiber core to be coated 601 to draw the fiber 601 through a sol-gel 603 in the reservoir 605. The tether 620 may be of any suitable size and composition, and may be, for example a string or cord of glass fiber, nylon, cotton or other flexible fiber. In operation, the fiber core to be coated 601 is fed through the fiber feed guide 605 and then attached to the tether 620 at an attachment 625. The attachment 625 can be formed from a reliable adhesive bond, for example Crystal Bond™ 609. For example, a fiber core 601 may be attached to a tether 620 as follows: Once the fiber 601 is visible in the top end 614 of fiber feed guide capillary tube 610, a piece of tape is used to make sure the fiber does not fall back through the guide until it is secured. A tether 620 with a small amount of Crystal Bond is brought into close proximity with the top face of the fiber 601. The tether 620 is then aligned carefully with the fiber 601 overlapping approximately 1 mm at the upper end of the fiber 601. The Crystal Bond at the end on the tether is gently heated with a torch until it is soft and the tether and the fiber are brought together. A reliable attachment of the tether 620 to the fiber 601 is formed when the Crystal Bond cools.

In various embodiments, the apparatus 600 can further include a spooling drum 630 to which the tether is attached for drawing a tethered fiber 601 through a sol-gel 603 in the reservoir 605 at a substantially even rate. Referring again to FIG. 3, the spooling drum 630 is mounted vertically above the reservoir 605, for example on mount 640, such that pulling force is generated by the rotation of spooling drum 630 drawing the tether 620 upward as it wraps (spools) around the drum 630. The spooling drum 630 is located such that a vertical vector tangent to its surface—i.e., tangent at the point on the drum 630 which first contacts the tether 620 as it is spooled—is vertically aligned with the fiber feed guide 610. The spooling drum 630 may be attached to the mount 640, and powered and controlled by a pulling motor 635, such as a DC servo motor powered by DC of a few volts, or a lead screw powered by a motor, and associated controller 637, which may be at least partially contained within the spooling drum 630.

Broadly speaking, the controller 637 may be defined as electronics having various integrated circuits, logic, memory, and/or software (stored, for example, in volatile or non-volatile memory) that receive instructions, issue instructions, control operation, enable pulling or drawing operations, and the like. The integrated circuits may include chips in the form of firmware that store program instructions, digital signal processors (DSPs), chips defined as application specific integrated circuits (ASICs), and/or one or more microprocessors, or microcontrollers that execute program instructions (e.g., software). Program instructions may be instructions communicated to the controller in the form of various individual settings (or program files), defining operational parameters for carrying out a particular process or operation.

Once the attachment 625 of the fiber core to be coated 610 to the tether 620 is made, a sol-gel is added to the reservoir 605. The reservoir 605 should be filled with sol-gel to a level such that there is sufficient volume to coat the fiber to the desired extent above the level of the top 614 of the fiber guide tube 610 in the reservoir 605. In some embodiments, the volume of the reservoir is about 0.2 ml, about 0.15 ml of sol-gel is used, and the top surface of the sol-gel 603 in the reservoir 605 about 1 mm to 10 mm, or 1 mm to 3 mm, above the top of the fiber feed guide 610.

Sol-gel 603 in the reservoir 605 can then be applied to the optical fiber core 601 in a draw coating procedure by drawing the fiber core 601 upward through the reservoir 605 of the sol-gel 603 by pulling it with the tether 620. The draw coating may be conducted at room temperature and ambient pressure, and should be conducted in a clean environment, substantially free of airborne particulates (e.g., dust).

In many embodiments, for enhanced results, the pulling of the tether upwards is done at a controlled and steady draw rate driven by a motor and controlled by a controller connected with the spooling drum. A suitable or optimum draw speed for the crystal to be coated with the prepared sol is experimentally determined by using a trial fiber of the same or similar dimensions. This draw rate may be, from about 5 mm/min to 50 mm/min, depending on the viscosity of the sol-gel. For example, for an undoped YAG sol-gel coating a 100 μm rare earth element-doped (e.g., Yb, Nd, Er, Ho for example):YAG single crystal fiber, a suitable draw rate may be from about 10 mm/min to 35 mm/min. For a Lu:YAG sol-gel coating a 30 μm rare earth or transition metal (e.g., Cr):YAG single crystal fiber, a suitable draw rate may be from about 5 mm/min to 45 mm/min. For an Al₂O₃ sol-gel coating a 140 μm Yb-YAG fiber, a suitable draw rate may be from about 5 mm/min to 45 mm/min. For a CaGdAlO₄ (CALGO) sol-gel coating a 50 μm Yb:CALGO fiber, a suitable draw rate may be from about 5 mm/min to 50 mm/min.

In general, slower drawing speeds are used with more viscous sol-gels. There is no necessary a correlation between the fiber core diameter and the sol-gel viscosity. Higher viscosity sol-gels generally produce thicker coating layers. Functional coating layers of about 0.5 μm to 5 μm, for example about 1-3 μm, per layer; and of about 2 μm to 15 μm, for example about 3-10 μm, total cladding thickness can be applied to fiber cores with good results.

Solvent is then evaporated from the sol-gel-coated fiber, allowing sol-gel coating to dry very slowly for approximately 24 hours. Drying can be conducted ambient air, although humid conditions (e.g., a relative humidity greater than 40%) should be avoided so that the gel does not reabsorb moisture from the air, due to its hygroscopic nature. Alternatively, drying may be accelerated by conducting it at an elevated temperature, up to about 80° C. In either case, drying should be conducted in a clean environment, substantially free of airborne particulates (e.g., dust). In some embodiments, evaporating the solvent from the sol-gel coating on the optical fiber core is conducted inside an enclosed container substantially free of airborne particulates at about room temperature of about and at a relative humidity of no more than 40%.

Once dry to the touch, the coated fiber is heated to produce a sintered cladding. Depending on the sol-gel composition, the sintering may be at a temperature of about 500° C. to 1000° C. for several hours in a sintering oven that can accommodate the coated fiber without damage. One or more sintering stages may be used. In at least some embodiments, the drying container is separate from the sintering oven.

It has been found that the described sol-gel coating method can be enhanced in a variety of ways:

Sintering Process Profile

The sintering process may include a temperature profile having one or more heating stages. In many embodiments, a single stage is used, gradually rising, or ramping, from an initial temperature at or near room temperature to a final temperature at a prescribed rate. In other instances this initial stage is followed by one or more additional stages (for example, a total of two stages) characterized by a particular heating rate and a final temperature, again ramping from an initial temperature to the final temperature. In multi-stage sintering profiles, a subsequent stage may begin immediately following the completion of a prior stage. Or, there may be a period of time (from minutes to days, for example 1 hour) during which the temperature is held at the final temperature of the prior stage prior to initiation of the subsequent stage. Or, there may be a cooling period between the heating stages, during which the temperature is reduced, for example as low as room temperature, prior to initiation of the subsequent stage.

Among some specific examples of sintering profiles are for a pure YAG or Lu:YAG sol-gel coated on a single crystal Yb:YAG fiber core. In this instance, heating the sol-gel-coated optical fiber core from about room temperature to about 500° C. for about 3 hours at a ramp rate of about 0.8-1.5° C./min gives good results. In a second, multi-stage example, the sintering of an Al₂O₃ sol-gel coated on a single crystal Yb:YAG fiber core involves heating from about room temperature to about 200° C. for about 2 hours at a ramp rate of about 1.5° C./min, followed by a second heating stage up to about 1100° C. for about 2 hours at a ramp rate of about 4° C./min. Prior to the second heating stage, the coated fiber may be held at a temperature of 200° C. for a period, or may be cooled, for example to room temperature. In a third example, a pure CALGO sol-gel coated on a single crystal Yb:CALGO fiber core may be heated from about room temperature to about 500° C. for about 1 hour at a ramp rate of about 4° C./min for good results. Dopant concentrations for doped core substrates and sol-gels may be in the range of 1% to 10%.

Multiple Coatings to Improve Scattering Performance

The coating, drying and sintering processes can be repeated to obtain a cladding on the fiber core that provides beneficial properties, including low enough scattering to be functional as an optical fiber (i.e., at or approaching total internal reflection). It has been found that the applying (coating), evaporating (drying) and heating (sintering) operations can be repeated to form one or more additional cladding layers on the optical fiber, to good effect. In particular, in at least some instances it has been found that the quality of the cladding can increase dramatically after three successive sol-gel coating/drying/sintering rounds. In at least some embodiments, only after the third iteration does the scattering on the sol-gel cladding dramatically decrease so that substantially total internal reflection is achieved. In at least one such case, the scattering coefficient of the optical fiber drops from about 0.5 dB/m following the first two coatings, to less than 0.05 dB/m, low enough scattering to be functional as an optical fiber (e.g., at or approaching total internal reflection), following the third coating. The thickness of the coating layers does not appear, at least in all instances, to have a bearing on this effect; three coating layers has been determined to result in a dramatic decrease in scattering so that substantially total internal reflection is achieved.

### Sol-Gel Cladding Compositions

Optical fibers of various compositions may be made as described herein. Among the advantageous applications and results are optical fibers having a single crystal core and a polycrystalline cladding.

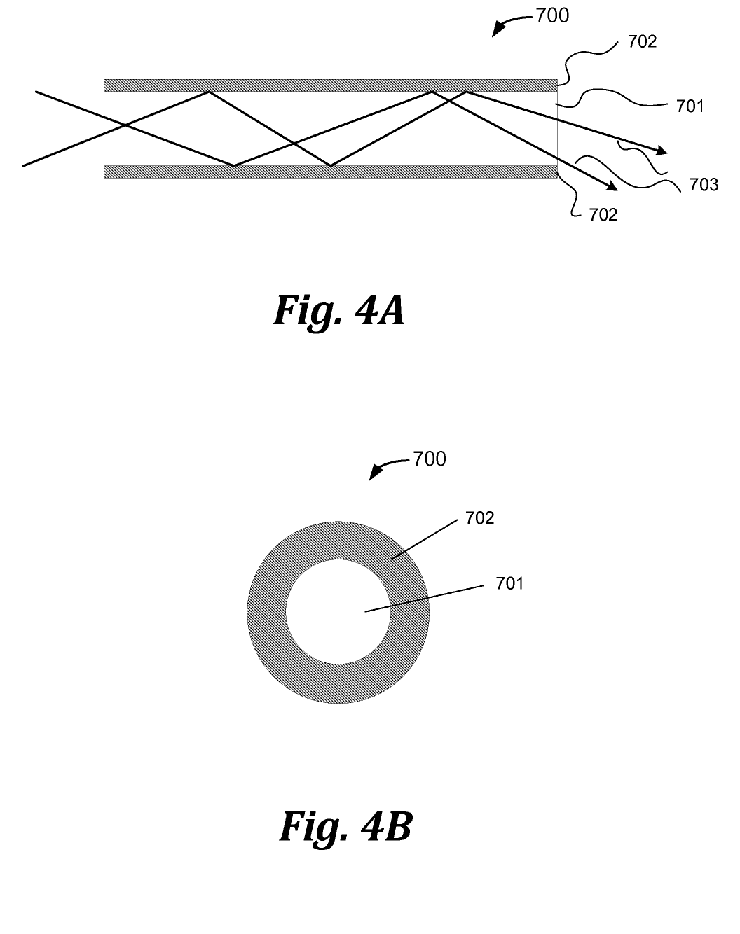

For ease of reference, FIGS. 4A and B provide longitudinal and axial cross-sections, respectively, of an optical fiber consistent with the disclosure herein. Referring to the longitudinal cross-section of FIG. 4A, the optical fiber 700 is shown with its constituent core 701 and cladding 702 parts. Also represented in the figure is the path of light 703 traveling through the optical fiber 700 illustrating total internal reflection. Light 703 traveling the optically dense medium of the core 701 hits the boundary between the core 701 and cladding 702. The cladding 702 is composed of a medium having a lower refractive index. The light 703 hits the boundary at an angle higher than the critical angle for the boundary, resulting in the light 703 being completely reflected back into the core. In this way, light 703 travelling in the optical fiber 700 is confined to the core 701 and is propagated with little or no loss.

This disclosure provides sol-gel-formulated cladding compositions, including a sol-gel composition consisting essentially of CaGdAlO₄ or Lu:YAG. These sol-gel compositions are not known to have previously been made or used for optical cladding purposes. The content and purity of these sol-gel compositions has been confirmed by X-ray diffraction (XRD) analysis.

In addition, optical fibers resulting from the sol-gel-based coating of these compositions as polycrystalline cladding on fiber cores, in particular single crystal fiber cores as described herein, is disclosed. Such all-crystalline optical fibers and are not known to have previously been made. Among some specific examples of such all-crystalline optical fibers are: rare earth or transition metal element-doped YAG, CALGO or sapphire cores clad with pure (undoped) YAG, Lu:YAG, Al₂O₃ or CALGO of lower refractive index.

### Examples

The following examples provide details illustrating various aspects of the preparation and advantageous properties of sol-gel methods, apparatus and compositions in accordance with the present disclosure. These examples are provided to exemplify and more clearly illustrate aspects of the disclosure and are in no way intended to be limiting.

### Example 1: YAG Cladding of a Single Crystal Fiber Core

### YAG Sol-Gel Synthesis

All reagents were obtained from Sigma Aldrich. 0.3387 g (1.500×10⁻⁴ mol) of yttrium oxide (Y₂O₃, 99.99%) is weighed out and placed into a clean flask and 30 mL of 0.2M Acetic acid is added to solvate the powder. The flask is then heated for approximately 1-3 hours at 60° C. after covering with Parafilm® avoiding evaporation.

The Stoichiometric amount of 1.8750 g (4.9983×10⁻³M) of aluminum nitrate nonahydrate (Al(NO₃)₃.9H₂O, >98%) is weighed and add to the previous mixture. In a separate container, 0.86528 M citric acid is prepared by weighing out 5.4549 g of citric acid(>98%) and dissolved in 30 mL of distilled water. This new solution is also added to the previous solution in the flask. After taking off the Parafilm®, the solution is heated at 80° C. for about 2-8 hours depending on viscosity of the solution needed. Sol-gel viscosity is determined by the amount of time the gel is allowed to condense at this stage. If the gel is too thick it will either crack when coated or the adhesion will be poor and droplets will form. In order to produce thin coatings that are crack free, the solution is not allowed to reach gelation. A suitable viscosity for coating fiber cores with cladding to form optical fibers is generally about 3-10 cSt, depending on the diameter of the fiber to be coated and the application rate.

### Annealing Post Growth

After the fiber and a ceramic ware dedicated to annealing were thoroughly cleaned with high purity solvents, the fiber was placed inside the ceramic ware and covered. For very thin flexible fibers, this can be done by coiling the sample in a round ceramic dish. For fibers that are less flexible, a long tube can be used. Annelaing is conducted in a furnace dedicated for annealing (e.g., a Barnstead Thermolyne furnace) at 1000° C. (7° C./min) for about 12 hours.

### Fiber Cleaning Before Coating

To minimize defects, the crystal or fiber to be coated was cleaned thoroughly by soaking in high purity isopropanol and placing inside an ultrasonic bath for about 10 minutes, repeating with a high purity ethanol, rinsing in a flow of isopropanol, and then drying with compressed gas.

### YAG Sol-Gel Dip Coating

The YAG gel was coated on the substrate by dip-coating it in the sol at 5 mm/min-50 mm/min. A brushless DC Servo motor was used to control the rate of dip/pull by increasing or decreasing the voltage. The film was then allowed to dry very slowly for approximately 8-24 hrs. When drying in air, high humidity, that is relative humidity in excess of 40%, should be avoided so that the gel does not reabsorb moisture from the air, due to its hygroscopic nature. Once dry to the touch, the sample was heated to 500° C. for 3 hours at a ramp rate of about 0.8-1.5° C./min. The coating/drying/sintering process was repeated until the desired thickness was achieved.

### YAG Sol-Gel Draw Coating

To coat a single crystal fiber thinner than 150 μm, a reservoir such as the one depicted in FIG. 3 is used. The fiber is inserted inside the capillary tube on the lower side of the container. Once the fiber is visible in the top end of the capillary tube, a very narrow but short piece of tape maybe used to make sure the fiber does not fall through until it is secured. Next, a string with a small amount of Crystal Bond is brought very close to the top face of the crystal. The string is then aligned carefully with the fiber and approximately 1 mm past the end of the fiber. The Crystal Bond at the end on the string may then be gently heated with a torch until it is soft and the string and the crystal are brought together. After the crystal bond is allowed to cool, the reservoir may be filled with the YAG sol-gel. The YAG sol-gel is then coated on single crystal fiber by pulling up the string at a controlled rate driven by a motor. For YAG sol, this draw rate maybe anywhere from 5 mm/min to 50 mm/min depending on the viscosity of the sol-gel (for example to coat a 50 μm fiber a pull rate of 25 mm/min may be used for one sol-gel and a pull rate of 5 mm/min may be used for a sol-gel of a higher viscosity. A suitable or optimum draw speed for the crystal to be coated with the prepared sol is experimentally determined by using a trial fiber of the same or similar dimensions. Once complete, the end of the fiber is cut free from the crystal bond and it is allowed to dry at room temperature inside a clean enclosed container.

To coat a fiber larger than 150 μm, the same type of reservoir used for a small fiber is used, without the aid of a capillary tube. For these sizes, the fiber is pierced through the lower side of the membrane and pulled in the same manner as before.

### Drying/Sintering Procedure

The film is then allowed to dry slowly for approximately 8-24 hrs. When drying in air, high humidity, that is relative humidity in excess of 40%, should be avoided so that the gel does not reabsorb moisture from the air, due to its hygroscopic nature. Once dry to the touch, the sample was heated to 500° C. for 3 hours at a ramp rate of about 0.8-1.5° C./min. The coating/drying/sintering process was repeated until the desired thickness was achieved.

### XRD of Powder Made in Same Manner

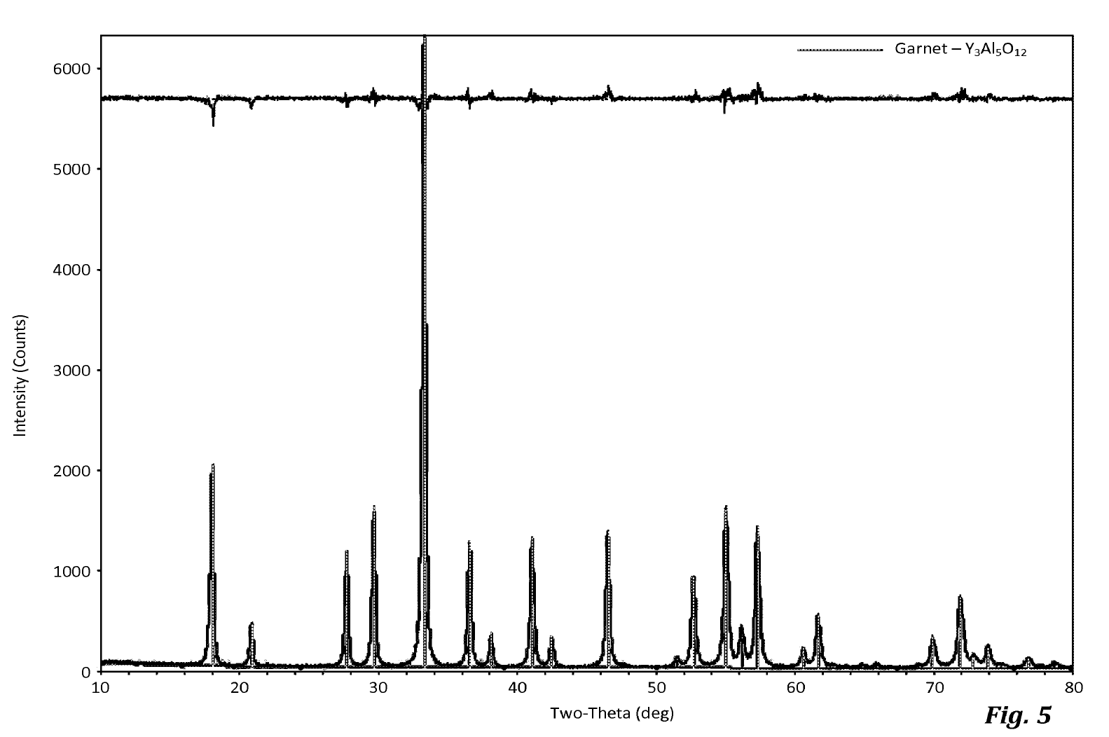

To provide a cladding for LHPG-grown YAG fibers doped with ions such as Er, Yb, and Ho, which do not spontaneously congregate at the core, sol-gel processes to coat the as-grown fibers with polycrystalline YAG were developed. Yttrium oxide (Y₂O₃) was chosen as the Y source, and aluminum nitrate nonahydrate (Al(NO₃)₃.9H2O) as the Al source. As shown in the plot of FIG. 5, X-ray diffraction studies confirmed that this procedure yielded single-phase cubic-face YAG.

### Scattering Results for YAG Cladding

To gain maximum lasing efficiency, it is important to reduce scattering in single crystal fibers to levels close to the ones of silica fibers (e.g., about 10 dB/km). Experimental results have demonstrated that scattering loss in optical fibers with single crystal Yb:YAG fiber cores can be reduced by annealing the fibers at 1100° C. for 12 hours and/or by cladding them with pure YAG made by sol-gel processing, as described herein.

Table 1 shows the scattering results. As can be seen from the data in the table, a single crystal YAG fiber having an average diameter of about 120 μm and a length of about 12 cm had a scattering coefficient of about 2.80 dB/m after formation and prior to annealing, 0.58 after annealing, 0.47 after two layers of pure sol-gel YAG application as described herein, and 0.044 dB/m after two layers of pure sol-gel YAG application. Therefore, there is a dramatic improvement in scattering observed following the third layer of YAG application, and the resulting cladding reduces scattering at the core/cladding interface of the optical fiber to about the level of silica fibers.

TABLE 1

| | | | | Scattering Coefficient | Scattering Coefficient | After 2nd Layer of | After 3rd Layer of |
|---|---|---|---|---|---|---|---|
| Seed Speed | Feed Speed | Length | Fiber Diameter | (dB/m) | (dB/m) | Sol- Gel Coating | Sol-Gel Coating |
| (mm/min) | (mm/min) | (mm) | (mm) | Before Annealing | After Annealing | (dB/m) | (dB/m) |
| 5 | 0.12 | 121 | 0.12 | 2.80 | 0.58 | 0.47 | 0.044 |

A prior fabrication of a transparent, crack-free and effective YAG optical fiber cladding is unknown.

### Example 2: 3% Lu:YAG Synthesis Procedure

All reagents were obtained from Sigma Aldrich. 0.3284 g (1.454×10⁻³ mol) of yttrium oxide (Y₂O₃, 99.99%) is weighed out and placed into a clean flask and 30 mL of 0.2M Acetic acid is added to suspend the powder. The flask is then heated for 1-3 hours at 60° C. after covering with Parafilm® avoiding evaporation. Extra care should be taken to make sure that the powder doesn't settle at the bottom of the flask.

1.8750 g (4.9983×10⁻³ mol) of aluminum nitrate nonahydrate (Al(NO₃)₃. 9H₂O, >98%) and 0.0422 g (8.997×10⁻⁵ mol of Lutetium nitrate hydrate (Lu(NO₃)₃.×H₂O) are weighed and add to the previous mixture. In a separate container, 0.8648 M citric acid is prepared by weighing out 5.4520 g of citric acid (>98%) and dissolved in 30 mL of distilled water. This new solution is also added to the previous solution in the flask. After taking off the Parafilm®, the solution is heated at 80° C. for approximately 8-24 hours depending on viscosity of the solution. After an hour or two into heating, the solution should turn clear with no visible suspended powder. Once the desired viscosity is reached (prior to complete gelation), the transparent gel may be used to coat fibers.

### Draw Coating Procedure

To coat a fiber thinner than 150 μm, a reservoir such as the one depicted in Schematic 1 is used. The fiber is inserted inside a capillary tube on the lower side of the container. Once the fiber is visible in the top end of the capillary tube, a very narrow but short piece of tape maybe used to make sure the fiber does not fall through until it is secured. Next, a string with a small amount of Crystal Bond is brought very close to the top face of the crystal. The string is then aligned carefully with the fiber and approximately 1 mm past the end of the fiber. The Crystal Bond at the end on the string may then be gently heated with a torch until it is soft and the string and the crystal are brought together. After the crystal bond is allowed to cool, the reservoir may be filled with the Lu:YAG sol-gel. The YAG gel is then coated on crystal (e.g., a Yb:YAG single crystal fiber) by pulling up the string at a controlled rate driven by a motor. For Lu:YAG, this draw rate maybe anywhere from 5 mm/min to 45 mm/min depending on the viscosity of the gel (for example a pull rate of 12 mm/min is used to coat a 300 μm fiber). Once complete the end of the fiber is cut free from the crystal bond and it is allowed to dry at room temperature inside a clean enclosed container.

To coat a fiber larger than 150 μm, the same type of reservoir used for small fiber without the aid of a capillary tube is used. For these sizes, the fiber is pierced through the lower side of the membrane and pulled in the same manner as before.

### Drying/Sintering Procedure

The film is then allowed to dry slowly for approximately 8-24 hrs. When drying in air, high humidity, that is relative humidity in excess of 40%, should be avoided so that the gel does not reabsorb moisture from the air, due to its hygroscopic nature. Once dry to the touch, the sample was heated to 500° C. for 3 hours at a ramp rate of about 0.8-1.5° C./min. The coating/drying/sintering process was repeated until the desired thickness was achieved.

### Example 3: Al₂O₃ Sol-Gel Procedure

Inside an Erlenmeyer flask, 11.2541 g (3.0000× 10-3 mol) of aluminum nitrate nonahydrate (Al(NO₃)₃.9H₂O, >98%, Sigma Aldrich) is dissolved in 60 mL distilled water. 15.7648 g of citric acid (7.5020× 10-2 mol, >98%) is added to this solution and the mixture is allowed to stir for 1-3 hours at 60° C. (sol is still clear at this point). See, e.g., Li, Jiang, et al. “Low temperature synthesis of ultrafine α-Al 2O3 powder by a simple aqueous sol-gel process.” Ceramics International 32.5 (2006): 587-591. Then the solution is heated at 80° C. uncovered for 8+ hours until the desired viscosity is reached as determined by testing on trial fibers of dimensions similar to the fiber to be coated. At this point, a hint of yellow appears as the volume decreases and the transparent gel may now be used to coat fibers. In order to produce thin coatings that are crack free, the solution is not allowed to reach gelation.

### Draw Coating Procedure

To coat a single crystal fiber thinner than 140 μm, a reservoir such as the one depicted in FIG. 3 is used. The fiber is inserted inside the capillary tube on the lower side of the container. Once the fiber is visible in the top end of the capillary tube, a very narrow but short piece of tape maybe used to make sure the fiber does not fall through until it is secured. Next, a string with a small amount of Crystal Bond is brought very close to the top face of the crystal. The string is then aligned carefully with the fiber and approximately 1 mm past the end of the fiber. The Crystal Bond at the end on the string may then be gently heated with a torch until it is soft and the string and the crystal are brought together. After the crystal bond is allowed to cool, the reservoir may be filled with the Al₂O₃ sol-gel. The Al₂O₃ sol-gel is then coated on single crystal fiber by pulling up the string at a controlled rate driven by a motor. For Al₂O₃ sol, this draw rate maybe anywhere from 5 mm/min to 45 mm/min depending on the viscosity of the gel (for example Al₂O₃ sol-gel was coated on a 26 μm fiber at a draw speed of 37 mm/min with good results). Once complete the end of the fiber is cut free from the crystal bond and it is allowed to dry at room temperature inside a clean enclosed container.

To coat a fiber larger than 150 μm, the same type of reservoir used for a small fiber is used, without the aid of a capillary tube. For these sizes, the fiber is pierced through the lower side of the membrane and pulled in the same manner as before.

### Drying/Sintering Procedure

The film is then allowed to dry very slowly for approximately 23-26 hrs. When drying in air, high humidity, that is relative humidity in excess of 40%, should be avoided so that the gel does not reabsorb moisture from the air, due to its hygroscopic nature. Once dry to the touch, the sample is heated to 200° C. for 2 hours at a ramp rate of 1.5° C./min and then again at 1100° C. for another 2 hrs at a ramp rate of 4° C./min. For this sol-gel, a two-step drying/sintering procedure prevents non a phases in the final Al₂O₃.

### XRD of Powder Made in Same Manner

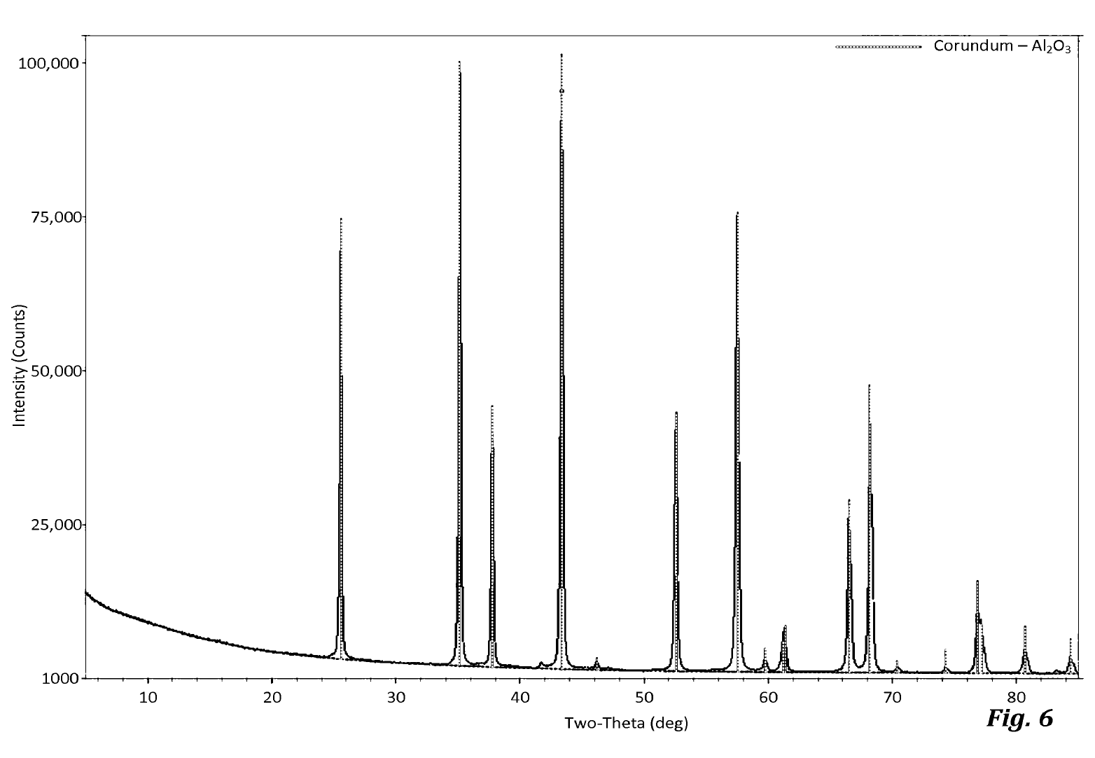

As shown in the plot of FIG. 6, X-ray diffraction studies confirmed that this procedure yielded product entirely composed of the α-Aluminum Oxide (Corundum).

### Example 3: CALGO Sol-Gel Procedure

1) 0.3300 g (1.821×10-3 mol) of gadolinium oxide (Gd₂O₃, 99.999%) are weighed in a laboratory scale and placed into a clean 100 mL Erlenmeyer flask. 60 mL of 0.2M Acetic acid are added to the reaction flask.

2) The flask is then placed on a heating/stir plate for approximately 3 hours at 65° C. after covering with Parafilm® avoiding evaporation. The mixture is stirred with a low motor speed of ‘2’ until all the powder has been fully dissolved.

3) A stoichiometric amount of 0.6831 g (1.821×10-3 mol) of aluminum nitrate nonahydrate (Al(NO₃)₃.9H2O, >98%×10-3 mol) and 0.4300 g of Ca(NO₃)₂.4H2O (1.821×10-3 mol, 99.997%) are weighed in a laboratory scale and added to the previous mixture.

4) In a separate container, 0.8652M citric acid is prepared by weighing out 1.914 g of citric acid(>98%) and dissolving it in 30 mL of distilled water.

5) The two solutions are combined in the original Erlenmeyer flask and the Parafilm is removed.

6) The reaction mixture is heated to 80 degrees to condense the solution to the desired viscocity.

7) 1 mL of Ethylene glycol is added to the reaction mixture once its volume has been reduced to 50 mL.

8) The mixture is further simmered until it has reached a volume of 4 mL. This can be checked by drawing the liquid into a clean graduated pipette and measuring its volume.

9) The thickened sol-gel is transferred into a glass vial with cap and saved for coating.

This gel is stable and can sit at ambient temperatures for an indeterminate time. It can be reused for multiple coatings.

### Dip Coating and Sintering Procedure

Mounting Crystal:

1) An alumina tube of diameter 1.60 mm is scored and cut to a length of about 20 mm.

2) A heaping amount of moist alumina paste is applied to one end of the tube.

3) The crystal to be coated is placed on an elevated surface with one end of it protruding from the edge of the surface.

4) Using flat metal tweezers to hold the alumina tube 1 to 2 mm of the crystal's protruding end is dipped into the alumina paste. The crystal and tube are aligned so to be as parallel as possible.

5) Indirect flame from a blow torch is applied to heat and slowly cure the paste.

6) The assembly is clamped with an alligator clip and set aside in a dust free area for later use.

Preparing Reservoir:

1) A long Pasteur pipette is cut slightly above the tapered region using a saw, or by scoring and breaking. The thin end of the pipette is scored to yield a reservoir that is longer than the crystal to be coated. The reservoir is then sealed by applying direct flame from a blow torch to the tip.

2) Sol-gel is transferred into the coating reservoir using a new Pasteur pipet. This is done carefully by fully inserting the sol-gel containing pipette into the reservoir, injecting the gel slowly while simultaneously withdrawing the tip until the reservoir is almost full.

3) Air bubbles that get trapped inside the reservoir are released by tapping or flicking gently.

4) Additional sol-gel is added to fill up the reservoir past the rim to form a convex meniscus.

Mounting on Dip Coater:

1) The crystal is mounted on the dip coater by attaching the alumna tube/crystal assembly to the line. Depending on the dip coating type the crystal is attached using tape or a collet.

2) The sol-gel reservoir is positioned directly underneath the fiber using a laboratory clamp.

3) The fiber is lowered into the sol-gel reservoir at a steady speed until it is submerged to about 1 to 2 millimeters below the alumina paste portion.

4) The fiber is allowed to soak in the solution for two minutes and subsequently drawn at the following speeds: 15 mm/minute for fibers below 100 μm and 20 mm/min for thicker fibers. The sol-gel reservoir is stored in a dust free environment for future use.

5) The fiber is carefully removed from the dip coater, clamped with an alligator clip and heated in a laboratory oven at a temperature of 75° C. for 30 minutes and then at a temperature of 100° C. for 30 additional minutes.

6) After an hour of heating the oven is turned off and allowed to cool. The crystal is retrieved and stored in a dust free environment.

Annealing Phase:

For crystals shorter than 70 mm a specialized alumina mold is fabricated out of alumina tubes and alumina paste. This fixture contains holes large enough to hold the crystal in an upright position. Longer fibers can be placed inside a hollow alumina tube.

1) Shorter fibers are mounted on alumina mold to ensure that no part of it comes in contact with any surface.

2) The mold and crystal are placed inside an inverted crucible with cover and heated in a programmable laboratory furnace with the following parameters: Temperature=500° C., ramp rate=3° C./minute, dwell time=90 minutes.

3) Longer fibers are placed inside the hollow alumina tube in a way that only the tip of the fiber comes in contact with the surface. This is accomplished by pasting a bar at the opening of the tube which elevates one end of the fiber.

4) The oven is allowed to cool below 60° C. before the annealed fiber is retrieved and stored in a dust free environment.

### XRD of Powder Made in Same Manner:

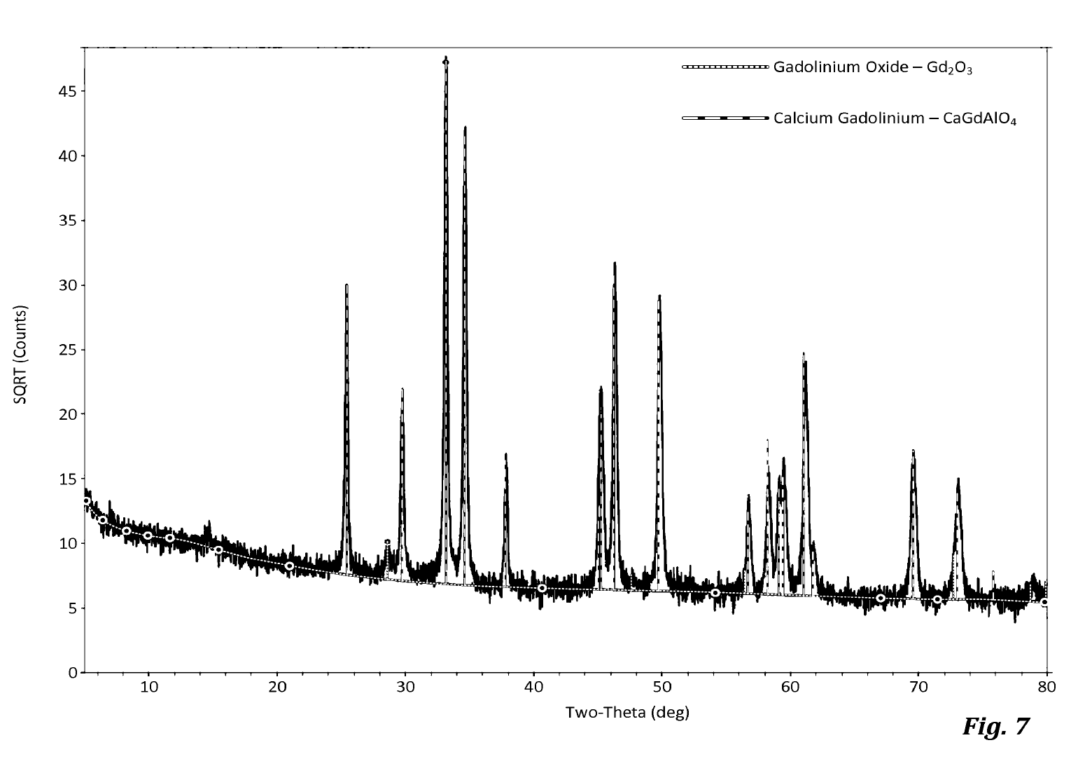

As shown in the plot of FIG. 7, X-ray diffraction studies confirmed that this procedure yielded 98.7% to 100% CaGdAlO₄ (CALGO).

Extra Coats:

For additional coats, the same gel reservoir and assembly is reused and coating procedure is repeated as before.

### CONCLUSION

It will be understood that unless features in any of the particular described implementations are expressly identified as incompatible with one another or the surrounding context implies that they are mutually exclusive and not readily combinable in a complementary and/or supportive sense, the totality of this disclosure contemplates and envisions that specific features of those complementary implementations can be selectively combined to provide one or more comprehensive, but slightly different, technical solutions. It will therefore be further appreciated that the above description has been given by way of example only and that modifications in detail may be made within the scope of the disclosure.

1. A method of making an optical fiber, the method comprising:
applying to an optical fiber core a coating of a sol-gel of material having a refractive index lower than that of the optical fiber core, forming a cladding precursor;
evaporating solvent from the cladding precursor; and
sintering the cladding precursor to form an optical fiber having a cladding comprising a concentric layer of the material on the optical fiber core.

2. The method of claim 1, wherein the optical fiber core is a single crystal fiber.

3. The method of claim 1, wherein the cladding is polycrystalline, and the cladding of the core achieves substantially total internal reflection for the optical fiber.

4. The method of claim 2, wherein the single crystal fiber core has an average diameter of about 150 μm.

5. The method of claim 2, wherein the single crystal fiber core comprises a rare earth element or transition metal-doped YAG or CALGO.

6. The method of claim 5, wherein the cladding comprises an undoped YAG, rare earth element or transition metal-doped YAG, Al2O3, or CALGO.

7. The method of claim 1, wherein the sol-gel is applied to the optical fiber core by drawing the fiber core upward through a reservoir of the sol-gel at room temperature and ambient pressure.

8. The method of claim 7, wherein the optical fiber core is drawn through the sol-gel at a rate of between about 5 mm/min to 50 mm/min.

9. The method of claim 8, wherein the optical fiber core is drawn through the sol-gel at a rate of between about 10 mm/min to 35 mm/min.

10. The method of claim 1, wherein the sol-gel coating applied to the optical fiber core has a thickness of about 1μ to 10 μm.

11. The method of claim 1, wherein the sintering comprises one or more periods (stages) of gradually raising (ramping) the temperature from an initial temperature to a final temperature at a prescribed rate.

12-14. (canceled)

15. The method of claim 11, wherein the temperature is held at the final temperature of the prior stage for a period of time prior to initiation of the subsequent stage.

16. The method of claim 11, wherein there is a cooling period between the heating stages, during which the temperature is reduced, for example as low as room temperature, prior to initiation of the subsequent stage.

17. The method of claim 5, wherein the sintering comprises heating a YAG-comprising sol-gel-coated optical fiber core from about room temperature to about 500° C. for about 3 hours at a ramp rate of about 0.8-1.5° C./min.

18-20. (canceled)

21. The method claim 1, wherein the evaporating is conducted at a temperature at or above room temperature, up to 80° C., for a period of about 24 hours.

22. The method claim 21, wherein the evaporating the solvent from sol-gel coating on the optical fiber core is conducted inside an enclosed container substantially free of airborne particulates at a relative humidity of no more than 40%.

23. The method claim 22, wherein the evaporating is conducted in a separate container from the sintering.

24. (canceled)

25. The method claim 22, wherein the applying, evaporating and sintering operations are performed a total of three times to form the cladding, and wherein the scattering coefficient of the optical fiber after the third coating is less than 0.05 dB/m.

26-27. (canceled)

28. A sol-gel coating apparatus, comprising:
a sol-gel reservoir having a bottom and sidewalls;
a fiber feed guide mounted in the bottom of the reservoir, the fiber feed guide for feeding a fiber entering the fiber feed guide from below into a sol-gel contained in the reservoir;
a tether mounted above the fiber feed guide and the reservoir, the tether for attachment of a fiber fed through the fiber feed guide to draw the fiber through a sol-gel in the reservoir.

29-35. (canceled)

36. An all-crystalline optical fiber, comprising:
a single crystal core; and
a polycrystalline cladding.

37-41. (canceled)
